(19) United States
(12) Patent Application Publication
(10) Pub. No.: US 2008/0312952 A1
(43) Pub. Date: Dec. 18, 2008

(54) Regulating Use Of A Device To Perform A Procedure On A Subject

(76) Inventors: Joseph V. Gulfo, New York, NY (US); Nikolai Kabelev, Irvington, NY (US); Dina Gutkowicz-Krusin, Princeton, NJ (US); Jon I. Klippel, Basking Ridge, NJ (US); Richard I. Steinhart, Ridgefield, CT (US)

Correspondence Address: FISH & RICHARDSON PC, P.O. BOX 1022, MINNEAPOLIS, MN, 55440-1022, US

(21) Appl. No.: 11/761,816

(22) Filed: Jun. 12, 2007

(51) Int. Cl. G06Q 50/00

(52) U.S. Cl. 705/2

(57) ABSTRACT

Among other things, whether a procedure can be performed on a subject using a procedure device, is governed based on control data prestored on a portable memory device; procedure data generated in connection with performing the procedure is stored on the portable memory device; the procedure data being stored in a manner that protects the privacy of the data in accordance with regulatory privacy restrictions that protect the subject with respect to the procedure.

### BACKGROUND

This description relates to regulating use of a device to perform a procedure on a subject.

### SUMMARY

In general, in an aspect, whether a procedure can be performed on a subject using a procedure device is governed based on control data prestored on a portable memory device; procedure data (e.g., including computerized analyses that produce diagnostic information, generated in connection with performing the procedure are stored) on the portable memory device; the procedure data are stored in a manner that protects the privacy of the data in accordance with regulatory privacy restrictions.

Implementations may include one or more of the following features. The procedure data includes diagnostic information produced by an analysis of raw procedure data generated by the procedure device. The procedure device includes a skin scanner. The portable memory device includes a memory card. The procedure includes a skin scan. The procedure data includes privacy protected medical information of the subject (e.g., including computerized analyses that produce diagnostic information). The regulatory privacy restrictions include HIPAA (Health Insurance Portability and Accountability Act) regulations.

In general, in an aspect, a computer associated with a procedure device is used to store, on a portable memory device, digital information associated with performance of a succession of similar procedures on a subject using the procedure device. A time period is tracked that elapses during the performance of the succession of the similar procedures. When the elapsed time period exceeds a predetermined period representing a single session, the storage of digital information associated with any subsequent similar procedures on the portable memory device and/or the operation of the procedure device under the authority of the portable memory device is restricted.

Implementations may include one or more of the following features. The predetermined period is shorter than five hours. The procedure device includes a skin scanner. The portable memory device includes a memory card. The procedure includes a skin scan.

In general, in an aspect, a computer that is owned by a supplier is lent to a clinician. Portable memory devices are sold to the clinician for use with the computer in regulating the use of a procedure device to perform procedures on a subject and enabling data generated in connection with the performance of the procedures to be stored on the portable memory devices. The generated data are stored on the portable memory devices, and not stored on the computer, in a manner that enables the clinician to comply with privacy regulations that protect the subject with respect to the data.

Implementations may include one or more of the following features. The procedure device includes a skin scanner. The portable memory devices include memory cards. The procedures include skin scans. The privacy regulations include HIPAA regulations.

In general, in an aspect, a physician uses a computer associated with a skin scanner to store, on a memory card, digital information associated with performance of a skin scanning procedure on a patient using the skin scanner, and the physician obtains advice from a consultant with respect to the patient by providing the digital information to the consultant from the memory card.

Implementations may include one or more of the following features. The digital information is provided by delivering the memory card to the consultant. The digital information is provided by accessing the information on the memory card at a location of the physician and communicating it electronically to the consultant. The providing of the digital information complies with privacy regulations that protect the patient with respect to the information.

In general, in an aspect, a supplier sells memory cards to a clinician for controlling the use of a procedure device to perform procedures on subjects. Each of the cards authorizes a specified number of a specific procedure to be performed. Information is received, from a computer that interacts with the cards, at a host controlled by the supplier, to prevent uses of the procedure device to perform procedures that are not authorized by the cards.

Implementations may include one or more of the following features. The clinician includes a dermatologist. The procedure device includes a skin scanner. The procedure includes a skin scan. The information is received through an electronic communication network.

In general, in an aspect, one image of a skin lesion is acquired at one time and stored on a first portable memory device. At a later time, a second image of the skin lesion is acquired and stored on a second portable memory device. A comparison of the one image and the second image is enabled by accessing the images from the portable memory devices using a computer.

Implementations may include one or more of the following features. The skin lesion includes a mole. The portable memory devices include memory cards. The images include digital images generated by a skin scanner. In some implementations, the comparison is performed automatically, for example, without human intervention.

In general, in an aspect, a computer associated with a procedure device is used to store, on a portable memory device, digital information associated with performance of a procedure on a subject using the procedure device. A portion of the digital information is restricted. At least some of the restricted information is permitted to be accessed by the computer associated with the procedure device. In connection with enabling a second computer to access at least some of the digital information on the portable memory device that is not restricted, access is allowed by the second computer to at least some of the restricted information (provided that the access and use do not violate privacy regulations).

In general, in an aspect, a computer associated with a procedure device is used to store, on a portable memory device, digital information associated with performance of a procedure on a subject using the procedure device. An image is also stored on the portable memory device that relates to the procedure and is generated by an imaging device that is separate from the procedure device.

Implementations may include one or more of the following features. The procedure device includes a skin scanner. The portable memory device includes a memory card. The procedure includes a skin scan. The imaging device includes a digital camera. The image includes a photograph of an area of the subject that is the subject matter of the procedure. The image is stored on the portable memory device by the computer, or by another device.

In general, in an aspect, it is determined that an actual usage of a procedure device by a user to perform a procedure on a subject corresponds to an available pre-paid permitted usage represented by indicia manifested on a portable device. The occurrence of the actual usage is reported to a remote location. And after the actual usage has occurred, the permitted usage is treated as no longer available.

Implementations may include one or more of the following features. The procedure device includes a skin scanner. The procedure includes a skin scan. The indicia include stored data. The portable device includes electronic storage. The portable device includes a memory card. Results of the actual procedure are stored on the portable device. The portable device is handled in accordance with privacy regulations. An entry in an accounting system is caused to reflect recognition of revenue associated with the actual usage. Data generated by the procedure may be analyzed and a corresponding diagnosis may be produced automatically.

In general, in an aspect, memory devices that store data that represent authorized usages of a skin scanner are sold to physicians. In some cases, the memory devices may be donated for use with uninsured patients. Confirmation of actual usages of the skin scanner corresponding to the authorized uses is automatically receiving through a communication network. Based on the confirmation, a wide variety of actions can be taken. For example, in an accounting system, revenue corresponding to the actual usages is automatically recognized in response to the confirmation.

In general, in another aspect, a portable storage device stores indicia representative of pre-paid permitted usage of a procedure device to perform a procedure on a subject.

Implementations may include one or more of the following features. A computer regulates use of the procedure device in accordance with the indicia stored on the portable storage device. A memory card on which is stored data represents prepaid permitted use of a skin scanner to scan regions of skin of a patient.

In general, in an aspect, a clinician is provided a pre-paid storage device, a computer, and a skin scanner. Based on interaction of the pre-paid storage device and the computer, the clinician is permitted to use the skin scanner to perform an authorized amount of scanning of skin of a patient to produce skin scan data. The computer is used to analyze the skin scan data to produce diagnostic information. The skin scan data and the diagnostic information are stored on the pre-paid storage device for later access and use by at least the clinician and others.

These and other features and aspects, and combinations of them, can be expressed as methods, apparatus, systems, program products, as means for performing a function, and in other ways.

Other advantages and features will become apparent from the description and the claims.

### DESCRIPTION

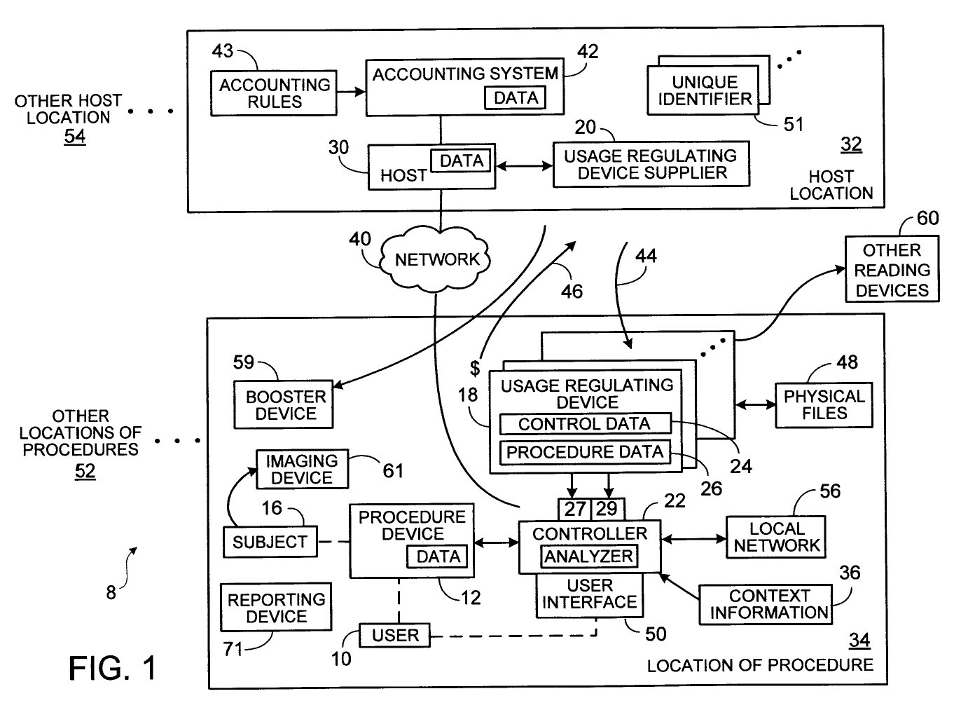

FIG. 1 is a block diagram of a system for regulating use of a device to perform a procedure on a subject.

As shown in FIG. 1, when a dermatologist (or other physician or diagnostic or therapeutic or cosmetic clinician, or other user) 10 uses a skin scanning device (or other diagnostic or therapeutic or cosmetic device, or other procedure device) 12 to scan a region of the skin (or perform any other diagnostic or therapeutic or cosmetic procedure, or other procedure) on a patient (or customer or other subject) 16, the cost (or the manner, context, circumstances, or other aspects) of using the device, e.g., to scan the skin, can be regulated using one or more digital memory cards (or memory sticks or memory disks or other memory devices or other usage regulating device or other devices) 18 that are sold, rented, or otherwise delivered by a supplier 20 to the user (or other buyer, renter, or recipient) 10. The use of the skin scanning device to scan the skin is regulated by a local computer or workstation (or other device, microprocessor, dedicated processor, chip, box, software, or controller) linked to (or associated with or operated with) the scanning device 22 based on data that indicate a number of available usages, a number of spent usages, conditions of usage, or other information on the basis of which usage can be controlled (or other kinds of control data) 24 and results and information from the procedure stored at least in part (and possibly also in other places) on the digital memory card.

In some implementations, each card when used becomes associated with a particular patient (when we use the word patient, we are referring broadly to any person or subject of the procedure) and will allow a predefined number of uses for a patient session, for example, a number of lesions to be scanned. If at one session, more lesions must be scanned than are provided by the card, another similar card or a booster card that has been prepaid will be used for the patient session. In other business models, the cost per patient for use of the skin scanner may be capped. After the patient session (which may end after, say, four hours), in some examples, the card is retired and no longer usable for additional procedures. In other cases, the card may be used for the same patient over a longer period of time (say, six months).

Although our discussion often refers to the example of a skin scan of lesions of concern done by a physician on a patient, this is only an example and the techniques described here can be implemented in a wide variety of ways using a wide variety of procedure devices, applied to a wide variety of subjects, in a wide variety of contexts.

The data stored on the memory card can include not only control data 24 that enable regulation of uses of the scanning device, but also skin scanning data (or other procedure data) 26. The procedure data can include data generated during a particular procedure, such as image data, spectral data, and other measured data from the skin scan as well as a wide variety of other procedure-related data including care-providers notes, results of physical examination, clinical impression, and historical information from the patient. Information may also be included that enables the exact location of each lesion on the patient's body (x and y coordinates, for example) as well as the diameter, shape, border irregularity, and distance from an anatomic landmark. This information may be entered manually by the user or generated automatically as part of the automatic assessment of a lesion provided by the computer. The procedure-related data could include the identity, demographics, and other information associated with a patient as well as information associated with the scan, including a date and time, a serial number, calibration information, scanning parameter information, images, and the results of analysis of the scan data. Thus, the procedure data include information that is specific to a particular procedure that has been done, while much of the control data concern regulating how and under what circumstances the procedure is to be (or was) done. The procedure data can include the results of computer analyses that provide diagnostic information including, for example, a recommendation to biopsy to rule-out melanoma.

Some or all of the control data stored on the memory card can be loaded onto the card from a computer (or other host) 30 that is owned or controlled by the card supplier (or other host entity) 20 and is located at a central office (or other host location) 32. Although generally it is contemplated that the control data will be loaded onto the card only at the host location, other parts of the control data on the memory card might be loaded or updated or locked or unlocked by the computer 22 at the physician's office (or other location of the procedure or other location) 34.

Regulation of uses of the scanning device to perform skin scans can be based not only on a number of usages permitted by the memory card, but also on other information provided to the computer, such as the identity of the physician, and the type, model number, and serial number of the scanner (and a wide variety of other context information) 36. Such additional information may also be used to evaluate whether the card will be accepted and registered and whether (in certain cases) the card will be allowed to be re-used.

For instance, if the user were to use the skin scanner on lesions that clearly were not intended to be addressed by the scanner (e.g., because they did not meet the commonly used ABCD criteria for evaluating lesions), in some implementations, the card should not be considered spent. Unless the ABCD criteria are met, it would be a waste to permit the scan to be charged against the authorized uses on the memory card. However, by inserting the card into the reader, the physician could implicitly get a free ABCD determination on a lesion, for if the computer declines to charge the scan to the card, the physician knows that the ABCD decision was negative, otherwise positive. Thus the memory card has the function to activate the system for use or to allow the skin scanner to be used for the procedure. In some implementations, however, the card need not be connected to the computer for the computer to provide an explicit free ABCD scan and determination. Then, if the physician wishes to proceed with a biopsy recommendation, he or she could insert the card and allow it to be charged by the computer for that recommendation. In another example, if the user indicates that the lesion is not pigmented, the card would not be considered registered or spent for the scan. In some examples, these additional uses could be made without cost to the user. In some implementations, additional charges would be made for the uses perhaps at different rates, commensurate with the level of analysis provided by the analyzer and system.

In other words, in some cases, the card can be used to regulate and charge the usage of the procedure device only for procedures that are meant to be evaluated by the device.

However, it is possible that this business model, permitting free limited scans to be done by the physician, could encourage the physician to use the skin scanner for inappropriate lesions without cost, while charging patients or insurance companies for the use of the skin scanner. In some implementations, the charge for inappropriate uses of the skin scanner could be made larger rather than smaller than for appropriate uses.

In some implementations, a determination must be made that the scanner is operating within specifications as confirmed by a periodic test required to be done. For example, every other week, a field test scan can be required to be done on a phantom target and the scanner calibrated accordingly. The system could require the results of the phantom test and validation that the scanner is operating within specifications to be reported to the host before any further scans could be done, or the computer could require permission from the host to allow for card acceptance and activation. If the skin scanner fails the self-diagnostic test, the memory cards should not be charged.

The memory cards are supplied to the users by physical delivery 44 in exchange for payments 46. The delivery and the payments are recorded by the host and reported to an accounting system 42. If free uses for indigent or uninsured patients are permitted, appropriate accounting entries are made for use of the associated cards.

The number of (and other control data or procedure data for) scans that have been performed is reported from time to time electronically by the computer through the Internet (or other communication network 40) to the host. The host in turn reports the performance of the scan to the accounting system 42 of the host entity. The accounting system then can, under Generally Accepted Accounting Principles (GAAP) (or other relevant accounting rules) 43, recognize or otherwise book as revenue the portion of the payment received for the memory card that is attributable to the scan that has been performed. This will also provide information as to whether unauthorized cards were used to activate the system, permitting the host to address fraudulent usage.

Some information associated with procedures that have been performed can be stored temporarily on the computer and later communicated to the host, for example, when the computer is also communicating other information to the host. After uploading, the information can be deleted from the computer at the procedure location.

A memory card that has been used for a scan can be stored in a typical physical patient file 48 associated with a patient. In that way, the card will automatically be handled in the same way as other patient information (such as x-rays, doctor's notes, and test results) for purposes of protecting patient privacy. The privacy-protected data need not be stored on the computer, the host, or any other non-complying device. Therefore, violation of privacy regulations, such as HIPAA, can be reduced or avoided.

In some implementations, the computer (and even the scanner) is the property of the party that supplies the memory cards and is lent to the physician for use in scanning. In those implementations, it could be argued to be a violation of privacy regulations for patient data to be stored on computer which is not owned by the physician. By storing the patient data on the memory card that is owned by the physician and stored in the patient's file, the requirements of privacy regulations can be met. Provisions could be made to assure that the data is deleted from the leased computer.

The procedure data and control data on the memory card can represent not only individual, distinct scans, but also can represent relationships between and among scans. For example, a patient's mole can be scanned on a number of occasions based on usages permitted by a card associated with the patient. In this example, the physician can insert a memory card previously used for a patient into the computer and immediately see differences between the prior scan stored on the card and a current scan that has just been completed and stored on a second card. For this purpose, the computer can include two different card reading devices 27 and 29 so that the old card can be read at the same time as the currently used card, and the images compared on the screen. Alternatively, the older card could be inserted, its image temporarily loaded into the RAM of the computer, and then the current card be re-inserted to provide the current image. The analyzer may be able to automatically analyze changes in a region of skin on the patient that includes the mole. Or, the system could display the two lesions side by side, or overlay the images, for review by the physician. The old scanned image and results of the analysis can be stored on the current card. This enables so-called mole mapping to be done more easily, more rigorously, and more effectively than with manual systems.

The computer includes a display that provides a user interface for the user 10 to interact with the system. The interface can enable the computer user to initialize the system, enter information, view images and other parts of the control data and procedure data, and generally control and manage the system.

A large number of physicians' offices and other health care delivery locations (and other procedure locations) 52 can be served by the system. A large number of host locations 54 can distribute cards and derive revenue from the scans that the cards regulate.

Communication among the host locations, the procedure locations, and between host and procedure locations can be through any network.

The computer can be connected to a local network 56 at the procedure location for communication with other devices (not shown) including other procedure devices, other computers, and other computers, at that location, for example.

Many elements of the system 8 for regulating use of a device to perform a procedure on a subject, shown in FIG. 1, store data related to regulating the use of the procedure device 12 in performing the procedure on the subject 16.

The data stored for that purpose can vary widely and include information about the user, the subject, the procedure device, the context, the usage regulating devices, the supplier, the host, the financial accounts, procedures that are been performed or are to be performed, and data generated by the procedure or on the basis of which the procedure is performed.

For example, the control data can include the number of procedures permitted to be performed; the number of subjects on which the procedures can be performed (typically one per card, although a system might allow use on multiple subjects per card provided that it could accommodate privacy concerns); the location or locations at which the procedures can be performed; the times and dates on which the procedures can be performed; the brand, model, and serial number of the procedure device that can be used to perform the procedure; the name, identity, age, and demographic classification of the subjects; the type of procedure that can be performed among those that are possible for the procedure device to perform; the location, identity, size, and type of physical file in which the usage regulating device is to be stored; the identities of related usage regulating devices within a group of such devices (for example one among a set of memory cards); the name, identity, and other characteristics of the user who is permitted to perform the procedures; the identity, location, and other characteristics of the supplier; the name and identifier of the account in the accounting system that corresponds to the usage regulating device; the price paid for the usage regulating device or for each procedure that is permitted to be performed; an indication of the number of usages that remain available and the number that have been used; and a record of how often, when, by whom, and for what purpose the control data have been changed or reported to the host.

The procedure data can include data representing the results of the procedure such as an indicator whether the procedure was successful or unsuccessful; the location at which the procedure was performed; the place on the subject where the procedure was performed; the brand, model, and serial number of the procedure device used to perform the procedure; the name, identity, age, and demographic classification of the subject of the procedure; the type of procedure; the location, identity, size, and type of physical file in which the usage regulating device is stored; the name, identity, and other characteristics of the user who performed the procedure; the data produced by the procedure including image or graphical data, non-image data, parameter values, calibration values, the results of analytical processes applied to any of the other data including ultimate results (yes or no recommendation for biopsy, for example); intermediate hypotheses about conditions of the subject; and information regarding the time, date, and nature of the individuals to whom the data may be sent for additional interpretation as well as the results of their interpretation.

Just as a physician can store paper information and x-rays or other images in a patient file and later forward it to another clinician for review and consultation, the control data and procedure data stored on a memory card can be forwarded to others, for example, simply by handing or sending the memory card to the consultant, or by fetching the data from the card and forwarding it electronically to the consultant. Thus, the consultation can be achieved by a store and forward technique in which the memory cards provide the storage and the forwarding is done (for example, by the computer associated with the scanner or another computer) by any of a variety of methods used in tele-medicine.

Although a main use of a given memory card may be a use by the dedicated computer associated with the scanner and provided by the card supplier and operated by a particular physician, it is also useful to permit other devices and computers, wherever located, to be able to read and use some of the data that are stored on the card. To achieve this, the format and manner in which the data are stored on the card may be based on commonly used formats or protocols, for example, *.tif files for images, or can be special formats. When the formats are special or certain data restricted, the devices that are used to read the cards may have special applications that can recognize the cards and make use of the stored unrestricted data. The special applications could be carried on the cards themselves and loaded onto the reading devices automatically when the card is inserted, or could be loaded onto the reading devices from storage media or by downloading from a communication network.

By appropriately configuring the memory card or the computer or the card readers, or a combination of them, different levels of permission may be arranged for different users to vary the amount of information that a given user can read from the card, or the manner and scope of the uses of the data.

The context information can include time and calendar information and environmental information including temperature, lighting, and humidity, for example.

Information stored on the procedure device can include the brand, model, serial number, identification of procedures that can be performed, number of usages, calibration data, and parameter values, among other things.

Information stored on the host can include identification of usage regulating devices, users, locations of procedures, procedure devices, and computers, histories of the numbers of procedures authorized and used for each user, location, procedure device, and usage regulating device.

Information stored on the accounting system can include the prices charged and money received on account of each procedure that is authorized to be performed, whether the procedure was performed successfully, and whether the procedure has actually been performed and therefore can be accounted for as recognized revenue.

For record-keeping, audit, and control purposes, each procedure that is authorized and represented on a usage regulating device can be assigned a unique identifier 51. In addition, each usage regulating device can be assigned a unique identifier each associated with the identifiers of its authorized procedures. Data that are stored on the system can be tied to the procedure identifier, the regulating device identifier, or both.

The user interface of the computer can enable the user to enter, update, change, view, and analyze either all of the data associated with the system or only some portion of the data that the user is authorized to access. The user interface enables the user to register with the system, update his registration, interact with the usage regulating devices, enable the procedure device to be used in accordance with authorized procedures covered by a usage regulating device, and indicate when a procedure has been completed.

The analyzer can do mathematical analysis, image processing, modeling, analytical processing, spectral analysis, noise reduction, filtering, logical processing, and any other kind of analysis that may be appropriate for the procedure. The analyzer can produce revised, updated, noise-reduced, processed values, parameters, images, sounds, and video, measurements, judgments, diagnostic information (as permitted by FDA), recommendations regarding clinical management, and answers. The user can control the operation of the analyzer through the user interface and in other ways. The outputs of the analyzer and the computer are forms of procedure data.

Some of the control data are stored on the usage control and storage device before it is sold and delivered. Some of the control data are locked and may not be changed by the user. Some of the control data may be changed under certain circumstances without authorization from the party that is the source of the usage control and storage device.

Based on the control data stored on the card (for example, the serial number of the scanner with which the card is permitted to be used), the computer uses (and sometimes updates) the data on the card and controls use of the scanner in a manner that conforms to the conditions represented by the control data. For this purpose, the system can be set up to require that the usage control and storage device (e.g., the card) be in communication with the computer at the time when the usage permitted by the data on the usage control and storage device is occurring. For example, the card will be inserted into the computer to activate the system, remain in the computer during the procedure and report generation, will be removed from the computer for storage, and can be reinserted into the computer or another computer for later use. When the computer communicates, to the host, the identifier of the card and the identifiers of the authorized scans to confirm that they have been used, the card typically will not be in the computer. In some implementations, the memory card or the computer may include broadband communication capability to permit the connection to the host to be continually available.

To control the usage of the procedure device in compliance with the requirements of the data stored on the usage control and storage device, the computer may need other data and information from the procedure device (for example, the type and model number, the serial number), the current date and time from a clock, and information that is stored on or entered into the computer regarding, for example, the name and identification number of the user, the name of the patient, and the number of scans that are to be done, among other things. By analyzing the conditions on usage against information about the conditions under which the use is to be made, the computer can determine whether to permit the usage control and storage device to be used.

Once the computer determines that usage is permitted, it may unlock and enable the procedure device so that the user can perform, e.g., a scan of a lesion. The data that are generated during the use of the procedure device (for example, image data, spectral data, calibration data, context data, and operating parameters) is returned to the computer where it can be stored and used for analysis and other purposes. The analysis can be controlled by the user through the user interface or in other ways, or can proceed automatically. The results of the analysis may be additional data to be stored and presented to the user.

The data resulting from the scan and the results of the analysis of that data will typically be stored back to the usage control and storage device by the computer. Because these are patient data that may be subject to regulatory or institutional restrictions on its storage and use, once the data are stored on the usage control and storage device, they may be deleted from the computer. As each permitted usage occurs, the data in the usage control and storage device are updated to record that usage as having been spent. In some examples, at the same time, the computer could report the identifiers of the card and the permitted usages to the host for verification and control purposes to preclude misuse or un-permitted overuse of a card or use of a bogus card. Digital signature, encryption, and other techniques could also be used to reduce or prevent fraud. After data related to a skin scanning session has been provided to the host, that data may be (or may be required to be) deleted from the computer.

The usage control and storage device would typically be stored in the physical patient file that contains papers, notes, x-rays, and results of tests. Because the physical patient file is already subject to treatment that complies with privacy and other usage and storage requirements, the usage control and storage device is automatically treated in the same way. In the example of the use and operation of the system of FIG. 1 introduced above, the user is a physician. The procedure device is a skin scanner of the kind that can provide a recommendation for or against the biopsy to rule-out melanoma, as well as other important diagnostic information for the physician to consider, as described, for example, in U.S. Pat. No. 6,081,612, Systems and Methods for the Multispectral Imaging and Characterization of Skin Tissue, U.S. Pat. No. 6,208,749, Systems and Methods for the Multispectral Imaging and Characterization of Skin Tissue, and other United States and international patents and patent applications owned by Electro-Optical Sciences, all of which are incorporated by reference here. The subject is a patient having lesions that may include melanomas. The computer runs analytical software to process scanned multi-spectral data derived from the lesion using the device image. The network is the Internet. The supplier is a company that supplies the procedure device. The host is a computer system. The accounting system is a computer-based business accounting system.

In this example, suppose the physician, in visually scanning the skin of the patient, identifies lesions that may be suspicious for being melanoma. The physician decides to use the skin scanner to indicate whether a biopsy is needed to determine whether or not the lesion is a melanoma. Previously the physician had bought from the supplier a set of memory cards each for use in up to twenty scans for one patient (though the maximum number may be different depending on the circumstances). The physician inserts the card into a reader on the computer, uses the user interface to enter information about the patient, and arms the card to permit the scans of the patient. In the first scan, spectral image data are acquired from one of the lesions and are analyzed to generate a recommendation regarding the need for biopsy. After the scan and analysis are done (and while the next scan and analysis is occurring in parallel), the next lesion is scanned and the data are analyzed. Up to a total of twenty (or some other suitable number of) scans are done on the patient.

When the scanning is done, the physician indicates the completion of the scans on the user interface. The computer performs the analysis to generate the biopsy recommendation and other diagnostic information with respect to all of the scans and transfers all of the procedure data, including the results of the analyses and control data that have been newly generated to the memory card, and stores a record on the card of how many scans were completed. The computer also sends to the host the identifier of the card and the identifiers of the scans that were performed. The communication of this information to the host may occur the next time the computer needs to connect through the network to the host, for example, to conduct a field phantom test. Or the communication may occur at the time of the use of the card as mentioned above. The computer may also send procedure data and control data (but without any privacy-protected personal information) to the host for analysis and aggregation with other similar information for use in improving future versions of the skin scanner and the analyzer. These data may be deleted from the computer at the procedure location after communication to the host has been accomplished.

At the host location, before the memory cards were distributed to the physician, the identifiers of the cards and the identifiers of the authorized scans were stored on each of the cards and copies were stored on the host and in the accounting system. When payment was received for the cards, a record of the payment was associated with the card identifiers in the accounting system.

When the host receives the report of scans that have been performed, the accounting system identifies the card and the scans that have been performed and changes the books to show that the amounts of received money corresponding to those scans are as recognized revenue for the business. By handling the reporting of the usage of the skin scanner electronically and automatically, subsequent to storage card consumption, the system assures that revenue is booked at the appropriate time. Because the information about cards and their use is communicated to the host and the accounting system, procedures can be used to reduce or prevent misuse or fraudulent use of the memory cards, or unauthorized card replication based on the card identifiers, for example.

When the scanning is finished and reported to the host location, the physician removes the card from the reader and places it into the physical file for the patient where it can be kept temporarily or indefinitely. At any time later, the card can be attached again to the computer or to another computer (from which, for example, unrestricted data can be accessed for report generation or lesion visualization or consultation) and the stored control data and the procedure data can be accessed, viewed, printed, and (if permitted) edited, or forwarded to a consultant. Rather than sending the memory card to the consultant, the memory card could be placed into the computer at the procedure location and the data sent electronically to the consultant. Similarly, when a patient changes doctors, or a doctor winds up his or her practice, the card or the data on the card could be forwarded to the new physician.

Therefore the same card serves both functions of containing the patient information in a portable form to be held in a physical patient file, and of facilitating the automated reporting of finished scans and the realization of revenue on an accounting system for the scans that have been completed.

As implied by the discussion above, the system regulates the use of the procedure device so that a procedure can be performed only on the basis of an interaction between the computer and the procedure regulating device. The action that is managed or controlled by the cooperation of the memory cards and the computer can be the performance of a single scan or a set of scans or all of the scans to be performed on the patient during a single visit, or scans to be performed on a single patient on one or more visits, or some other group or category of scans.

Thus, the control data in some examples can be understood to represent a right or authority of the physician to perform an authorized scan or set of scans based on the price paid for the card.

In some implementations, the memory card may not only control the uses of the procedure device, but may also control the activation of procedure device as an initial matter.

In examples of the operation of the system, a given memory card may be committed to a particular procedure for a particular subject and may be configured to be non-reusable (spent) after the procedure is done. Once the memory card has been committed, revenue associated with the card can be recognized for accounting purposes.

The host can determine revenue associated with usage of memory cards over a period of time based on the information sent by the computer to the host periodically (e.g., once a week, once every two weeks, etc.).

In some implementations, each memory card has unique identifying information, such as an electronic key. Each card can enable a limited use of the procedure device. Some memory cards can be in the form of “base” memory cards that are configured to enable the procedure device, say, to perform twenty scans during a particular examination of a particular patient. Other memory cards can be configured as booster devices 59 which can allow a number of scans in addition to the number allowed by the base card, for example, an additional fifteen scans, at a different cost per scan than the base card. If payment has been associated with both the base card and the booster cards, the revenues for the examination could correspond to the total number of devices used during the examination. Different booster devices could represent different quantities of additional scans (e.g., five additional scans or fifteen additional scans) for different charges per card.

Memory cards, in addition to being held in a patient file, can be moved from clinician to clinician, like an x-ray.

The procedure data that are to be stored on the usage regulating device may be temporarily stored on another memory device, local or remote to the computer. The data may be stored in a relational database or other data structure and, depending on the application, may include one or more patient records. Access rights, security, and protocols may be applied consistently with privacy regulations.

When the procedure data are to be recorded on the usage regulating device, a data record is first initialized on the memory card using identifying information such as an electronic key. The procedure device can recognize the presence of the key and become enabled in response to the recognition of the key.

In some examples, instead of regulating the use of the procedure device by numbers of procedures, the regulation could be based on time or another metric.

A reporting device 61 can use data stored on any of the other elements of the system to provide printed or online reports of usage, revenue, performance, quality, or any other useful information.

Other implementations and applications are also within the scope of the claims.

Without limiting the range of covered implementations and applications, for example, the procedure device could be any kind of device used for diagnosis or therapy or any other kind of procedure on a subject. The subject could be a human or an animal or even a device or piece of equipment. The user could be a physician, other health care worker, clinician, cosmetician, health and wellness spa employee, retail store clerk, the subject himself or herself, and any other person capable of using the device to perform the procedure and performing it in a regulatorily-compliant manner. The computer could be any kind of computer or processor, including a handheld device, a hardware only device, or a combination of hardware and software. The computer that regulates use of the procedure device could be embedded as part of the procedure device.

The usage regulating device could be a memory device storing coded information, a paper or other substrate printed with machine readable codes, such as bar codes, that are inextricably tied to the physical device, a dongle, a key, or any other device that can carry information about the available authorized usages and serve as the basis for controlling the use of the procedure device or the reporting of usages to the host. In some implementations, the usage regulating device can use a USB (Universal Serial Bus) protocol.

The manner in which the computer interacts with the usage regulating device need not be a physical or mechanical connection, but could be done wirelessly using radio frequency communication or light or accomplished in other ways.

Each usage regulating device may be partly or completely dedicated or committed to an individual procedure, a set of procedures, all of the procedures for a particular subject, or any other appropriate grouping or classification.

Each usage regulation device could be configured to be non-reusable as to each authorized scan or as to the whole card.

In addition to using the data on the card at the host to control recognition of revenue, a wide variety of other uses could be made of the information. For example, the information could be used to control inventory of the memory cards or replacement supplies for the procedure device; to generate automatic customer orders (for instance when their supply drops below a certain level), to schedule sales person visits (based on how many times the procedure device is used compared to a target rate of use), and to target various marketing strategies to the users.

Although we have sometimes described the usage regulating device as being a physical item such as a memory card, the usage regulating device could be a virtual device (such as a password protected file on a remote computer) or any other kind of physical device.

1. A method comprising
governing whether a procedure can be performed on a subject, using a procedure device, based on control data prestored on a portable memory device, and
storing on the portable memory device, procedure data generated in connection with performing the procedure, the procedure data being stored in a manner that protects the privacy of the data in accordance with regulatory privacy restrictions that protect the subject with respect to the procedure.

2. The method of claim 1 in which the procedure device comprises a skin scanner.

3. The method of claim 1 in which the portable memory device comprises a memory card.

4. The method of claim 1 in which the procedure comprises a skin scan.

5. The method of claim 1 in which the procedure data includes privacy protected medical information of the subject.

6. The method of claim 1 in which the regulatory privacy restrictions comprise HIPAA regulations.

7. A method comprising
using a computer associated with a procedure device to store, on a portable memory device, digital information associated with performance of a succession of similar procedures on a subject using the procedure device,
tracking a time period that elapses during the performance of the succession of the similar procedures, and
when the elapsed time period exceeds a predetermined period representing a single session, restricting the storage of digital information associated with any subsequent similar procedures on the portable memory device.

8. The method of claim 7 in which the predetermined period is shorter than five hours.

9. The method of claim 7 in which the procedure device comprises a skin scanner.

10. The method of claim 7 in which the portable memory device comprises a memory card.

11. The method of claim 7 in which the procedure comprises a skin scan.

12. A method comprising
lending to a clinician a computer that is owned by a supplier,
selling portable memory devices to the clinician for use with the computer in regulating the use of a procedure device to perform procedures on a subject and enabling data generated in connection with the performance of the procedures to be stored on the portable memory devices,
the generated data being stored on the portable memory devices, and not stored on the computer, in a manner that enables the clinician to comply with privacy regulations that protect the subject with respect to the data.

13. The method of claim 12 in which the procedure device comprises a skin scanner.

14. The method of claim 12 in which the portable memory devices comprise memory cards.

15. The method of claim 12 in which the procedures comprise skin scans.

16. The method of claim 12 in which the privacy regulations comprise HIPAA regulations.

17. A method comprising
a physician using a computer associated with a skin scanner to store, on a memory card, digital information associated with performance of a skin scanning procedure on a patient using the skin scanner, and
the physician obtaining advice from a consultant with respect to the patient by providing the digital information to the consultant from the memory card.

18. The method of claim 17 in which the digital information is provided by forwarding data in the memory card to the consultant.

19. The method of claim 17 in which the digital information is provided by accessing the information on the memory card at a location of the physician and communicating it electronically to the consultant.

20. The method of claim 17 in which the providing of the digital information complies with privacy regulations that protect the patient with respect to the information.

21. A method comprising
a supplier selling memory cards to a clinician for controlling the use of a procedure device to perform procedures on subjects, each of the cards authorizing a specified number of a specific procedure to be performed, and
receiving information, from a computer that interacts with the cards, at a host controlled by the supplier, to prevent uses of the procedure device to perform procedures that are not authorized by the cards.

22. The method of claim 21 in which the clinician comprises a dermatologist.

23. The method of claim 21 in which the procedure device comprises a skin scanner.

24. The method of claim 21 in which the procedure comprises a skin scan.

25. The method of claim 21 in which the information is received through an electronic communication network.

26. A method comprising
acquiring one image of a skin lesion at one time and storing the image on a first portable memory device,
at a later time, acquiring a second image of the skin lesion and storing the second image on a second portable memory device, and enabling a comparison of the one image and the second image using by accessing the images from the portable memory devices using a computer.

27. The method of claim 26 in which the skin lesion comprises a mole.

28. The method of claim 26 in which the portable memory devices comprise memory cards.

29. The method of claim 26 in which the images comprise digital images generated by a skin scanner.

30. The method of claim 26 in which the comparison is performed automatically.

31. A method comprising
using a computer associated with a procedure device to store, on a portable memory device, digital information associated with performance of a procedure on a subject - using the procedure device, a portion of the digital information being restricted,
permitting at least some of the restricted information to be accessed by the computer associated with the procedure device, and
in connection with enabling a second computer to access at least some of the digital information on the portable memory device that is not restricted, excluding from access by the second computer, at least some of the restricted information.

32. A method comprising
using a computer associated with a procedure device to store, on a portable memory device, digital information associated with performance of a procedure on a subject using the procedure device, and
storing on the portable memory device an image that relates to the procedure and is generated by an imaging device that is separate from the procedure device.

33. The method of claim 32 in which the procedure device comprises a skin scanner.

34. The method of claim 32 in which the portable memory device comprises a memory card.

35. The method of claim 32 in which the procedure comprises a skin scan.

36. The method of claim 32 in which the imaging device comprises a digital camera.

37. The method of claim 32 in which the image comprises a photograph of an area that is the subject matter of the procedure.

38. A method comprising:
determining that an actual usage of a procedure device by a user to perform a procedure on a subject corresponds to an available pre-paid permitted usage represented by indicia manifested on a portable device,
reporting the occurrence of the actual usage to a remote location, and
after the actual usage has occurred, treating the permitted usage as no longer available.

39. The method of claim 38 in which the procedure device comprises a skin scanner.

40. The method of claim 38 in which the procedure comprises a skin scan.

41. The method of claim 38 in which the indicia comprise stored data.

42. The method of claim 38 in which the portable device comprises electronic storage.

43. The method of claim 38 in which the portable device comprises a memory card.

44. The method of claim 38 also comprising storing results of the actual procedure on the portable device.

45. The method of claim 38 also comprising handling the portable device in accordance with privacy regulations.

46. The method of claim 38 also comprising causing an entry in an accounting system to reflect recognition of revenue associated with the actual usage.

47. The method of claim 38 also including analyzing data generated by the procedure and producing corresponding diagnostic information and a recommendation regarding the need for biopsy.

48. A method comprising
providing to physicians memory devices that store data that represent authorized usages of a skin scanner,
automatically receiving through a communication network, confirmation of actual usages of the skin scanner corresponding to the authorized uses, and
in an accounting system, automatically recognizing revenue corresponding to the actual usages in response to the confirmation.

49. An apparatus comprising
a portable storage device storing indicia representative of pre-paid permitted usage of a procedure device to perform a procedure on a subject.

50. The apparatus of claim 14 also including the procedure device.

51. The apparatus of claim 14 also including a computer to regulate use of the procedure device in accordance with the indicia stored on the portable storage device.

52. A memory card on which is stored data representing prepaid permitted use of a skin scanner to scan regions of skin of a patient.

53. A method comprising
providing to a clinician a pre-paid storage device, a computer, and a skin scanner,
based on interaction of the pre-paid storage device and the computer, permitting the clinician to use the skin scanner to perform an authorized amount of scanning of skin of a patient to produce skin scan data,
using the computer to analyze the skin scan data to produce diagnostic information, and
storing the skin scan data and the diagnostic information on the pre-paid storage device for later access and use by at least the clinician.

54. The method of claim 1 in which the procedure data includes diagnostic information produced by an analysis of raw procedure data generated by the procedure device.

55. A system for use in performing a procedure on a subject, comprising:
a procedure device to perform the procedure on the subject,
a memory to store information including one or more data selected from the group consists of procedure data generated when performing the procedure and control data related to governing delivery of the procedure to the subject, and
a control unit operatively connected with the procedure device and with the memory, the control unit being programmed to exchange the data with the memory.

56. A system according to claim 55, wherein the memory includes prestored control data.

57. A system according to claim 55, wherein the control unit is programmed to receive the procedure data generated when performing the procedure and deliver the generated procedure data to the memory for storage.

58. A system according to claim 57, wherein the control unit is programmed to deliver the generated procedure data to the memory in a manner that protects the privacy of the procedure data.

59. A system according to claim 57, wherein the control unit is programmed to store the procedure data in the memory in a manner that protects the privacy of the data in accordance with a predetermined rule restricting access to the procedure data.

60. A system according to claim 55, wherein the control unit is programmed to determine whether the procedure can be performed on the subject based on the control data.

61. A system according to claim 55, wherein the control unit is programmed to carry out at least the following steps:
receiving, from the procedure device, information associated with performance of a succession of procedures on the subject using the procedure device,
delivering the information to the memory for storage,
tracking a time period that elapses during the performance of the succession of the procedures, and
when the elapsed time period exceeds a predetermined period, stopping storing information associated with any subsequent procedures on the memory.

62. The system of claim 61 in which the predetermined period is shorter than five hours.

63. A system according to claim 55, wherein the memory comprises a portable memory which can be coupled, in a removable manner, with a memory reader associated with the control unit, and wherein the control unit is programmed to carry out at least the following steps:
regulating the use of the procedure device to perform procedures on the subject based on information retrieved from the portable memory, and
enabling data generated during the performance of the procedures to be stored on the portable memory, the generated data being stored on the portable memory control unit to protect the privacy of the subject with respect to the data.

64. A system according to claim 55, wherein the control unit includes a first processor operating at a first location, wherein
the first processor being programmed to carry out at least the following steps:
receiving from the procedure device information associated with the performance of the procedure on the subject,
delivering the information to the memory for storage, and
rendering the information stored on the memory accessible to the second processor.

65. The system of claim 64 in which the first processor is programmed to carry out at least the following steps:
retrieving the information stored in the memory,
forwarding the information retrieved from the memory to the second processor.

66. A system according to claim 55,
wherein the memory comprises a number of physically separated portions, each portion having an identity and storing information authorizing a number of the procedures to be performed using the procedure device,
the control unit comprising a first processor at a first location, interacting with the memory portions and with the procedure device, and a second processor communicating with the first processor and storing information related to authorized uses of the memory portions,
the first processor being programmed to carry out at least the following steps:
reading from the memory portions at least information concerning the identity of each memory portion and the information authorizing a number of procedures to be performed using the procedure device,
receiving information concerning user's intended use of the procedure device,
delivering to the second processor the memory portion identity information and the information concerning intended use of the procedure device,
receiving from the second processor information concerning whether the use of the procedure device is authorized,
preventing use of the procedure device to perform procedures that are not authorized, the second processor being programmed to carry out at least the following steps:
receiving from the first processor information concerning intended use of the procedure device, and the memory portion identity information,
verifying if the selected use of the procedure device complies with the uses authorized by the memory,
communicating to the first processor whether the use of the procedure device is authorized to prevent uses of the procedure device to perform procedures that are not authorized by the memory portions.

67. The system of claim 66 comprising an electronic communication network connecting the first processor and second processor, the processors exchanging the information through the electronic communication network.

68. A system according to claim 55, wherein the control unit comprises:
a first processor, associated with the procedure device and designed for cooperating with the memory, the first processor being programmed to:
store digital information associated with performance of the procedure on the subject using the procedure device, a portion of the digital information being restricted,
access at least some of the restricted information,
a second processor communicating with the first processor and/or with the memory, the second processor being programmed to:
access at least some of the information on the memory that is not restricted, and be excluded from accessing at least some of the restricted information.

69. A system according to claim 55 further comprising an imaging device connected to the control unit, the control unit being programmed to store on the memory:
data corresponding to an image that relates to the procedure and that is generated by the imaging device.

70. A system according to claim 55, wherein the memory stores indicia representative of an available pre-paid permitted usage of the procedure device, the control unit being programmed to:
determine that an actual usage of the procedure device by a user to perform a procedure on a subject corresponds to an available pre-paid permitted usage represented by the indicia manifested on the memory,
report the occurrence of the actual usage to a remote location, and
treat the permitted usage as no longer available, after the actual usage has occurred.

71. The system of claim 70 wherein an accounting system is connected with the memory and/or with the control unit, and the control unit is programmed to cause an entry in an accounting system to reflect recognition of revenue associated with the actual usage.

72. A system according to claim 55, wherein the control unit is configured to:
analyze the procedure data generated when performing the procedure, and
produce corresponding diagnostic information and/or a recommendation regarding the need for biopsy.

73. A system according to claim 55 further comprising:
an additional memory that store data representing authorized usages of the procedure device,
an accounting processor system,
a communication network operatively connecting the additional memory to the accounting processor system, the control unit automatically transmitting through the communication network, confirmation of actual usages of the skin scanner corresponding to the authorized uses,
the accounting processor system being programmed to:
receive confirmation of actual usages of the procedure device corresponding to the authorized uses, and
automatically recognize revenue corresponding to the actual usages in response to the confirmation.

74. A system according to claim 55,
wherein the memory comprises a first and a second portable memory devices,
wherein the procedure device comprises a skin scanner for acquiring a first image of a skin lesion and storing the first image on the first portable memory device, and for acquiring a second image of the skin lesion and storing the second image on the second portable memory device, and
wherein the control unit is programmed to carry out at least the following steps:
accessing the images on the portable memory devices,
comparing the first image and the second images.

75. The system of claim 74 in which the skin lesion comprises a mole.

76. The system of claim 74 in which the images comprise digital images generated by a skin scanner.

77. A system according to claim 55 in which the procedure device comprises a skin scanner.

78. A system according to claim 77 in which the skin scanner comprises an imaging device comprising a digital camera.

79. A system according to claim 55 in which the procedure comprises a skin scan.

80. The system of claim 74 in which the images comprise photographs of areas that are the subject matter of the procedure.

81. The system according to claim 55 in which memory comprises a portable memory device comprising a memory card.

82. The system according to claim 55 in which the procedure data includes privacy protected medical information of the subject.

83. The system according to claim 82 in which privacy protected medical information is regulated by HIPAA regulations.

84. A system comprising:
a skin scanner,
a memory card, and
a processor in communication with the skin scanner and with the memory card, the processor being programmed to carry out at least the following steps:
receiving from the skin scanner digital information associated with performance of a skin scanning procedure on a patient using the skin scanner,
storing on the memory card the digital information associated with performance of a skin scanning procedure on a patient using the skin scanner, and
rendering the digital information stored on the memory card remotely accessible to a consultant at a station remote from the processor to obtain advice with respect to the patient.

85. The system of claim 84 in which the processor is programmed to carry out at least the following steps:
retrieving data stored in the memory card,
providing the digital information to the consultant by forwarding to the remote station the data retrieved from the memory card.

86. The system of claim 85 in which the digital information is provided by accessing the information on the memory card at a location the scanning procedure is conducted and electronically delivering the digital information to the consultant.

87. The system of claim 84 in which the providing of the digital information complies with privacy regulations that protect the patient with respect to the information.

88. A system comprising
a pre-paid storage device,
a processor in communication with the pre-paid storage device, and
a skin scanner,
the processor being programmed to:
based on interaction of the pre-paid storage device, permit a clinician to use the skin scanner to perform an authorized amount of scanning of skin of a patient to produce skin scan data,
analyze the skin scan data to produce diagnostic information, and store the skin scan data and the diagnostic information on the pre-paid storage
device for later access and use by at least the clinician.

89. The system of claim 55 in which the procedure data includes diagnostic information produced by an analysis of raw procedure data generated by the procedure device.
